(19) United States
(12) Patent Application Publication
(10) Pub. No.: US 2025/0298924 A1
(43) Pub. Date: Sep. 25, 2025

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: Yuichi KAGEYAMA, Kanagawa (JP)

(21) Appl. No.: 19/082,336

(22) Filed: Mar. 18, 2025

(30) Foreign Application Priority Data
Mar. 25, 2024 (JP) 2024-048569

(51) Int. Cl. G06F 21/62; G06T 5/50; G06V 10/74; G06V 10/764; G06V 20/70

(52) U.S. Cl. CPC G06F 21/6254; G06T 5/50; G06V 10/761; G06V 10/764; G06V 20/70; G06T 2207/20221

(57) ABSTRACT

An information processing apparatus comprising: a determining unit configured to determine a concealed region for concealing personal information in a first image; a concealing unit configured to execute concealing processing on the first image on a basis of the concealed region; an applying unit configured to apply label information to the concealed region; a display unit configured to display the label information superimposed on a second image, which is a concealed image obtained by executing the concealing processing; and a training unit configured to perform training using the first image.

### BACKGROUND OF THE INVENTION

### Field of the Invention

The present invention relates to an information processing apparatus, a control method for an information processing apparatus, and a storage medium.

### Description of the Related Art

There has been much research performed relating to the field of image recognition in recent years, and many methods for recognizing an object region in an image using a convolutional neural network (CNN) have been proposed.

In machine learning, to obtain a machine learning model with high generalization performance, it is recommended that various patterns of images are used in training, and the number of training images, richness in variation, and the like affects accuracy. In particular, in regards to a human face, there are various combinations of race, gender, age, expression, face orientation, lighting conditions, and the like. Thus, there are many types of images required in order to increase the performance of a machine learning model for recognizing a human face.

Also, recent years have seen an increase in awareness surrounding the protection of personal information. This has brought requirements relating to anonymization and made collecting training image data without consent difficult. Personal information includes not only human faces, but also material showing an individual's name, name plates on a house, and the like. Image processing such as blurring and blanking out needs to be used on such images to protect personal information. In the case of such an image with concealed personal information, the user can upload the image without fear of the personal information being leaked. For example, for a community on the Internet that shares images for machine learning, this can help make more users upload images. Thus, machine learning engineers can ensure a variation of training images.

Japanese Patent Laid-Open No. 2019-79357 describes technology that generates personal information concealed images of people and uses the personal information concealed images in machine learning.

However, according to Japanese Patent Laid-Open No. 2019-79357, personal information concealed images are used in machine learning. Thus, the accuracy of the machine learning model may be reduced due to using personal information concealed images in the training. For example, when an unnatural image such as a partially blurred image is used in training, there is a possibility that this will generate unwanted noise during training leading to a decrease in accuracy. Also, images in which the human face is concealed cannot be used in training a machine learning model for detecting the position and size of human faces and a machine learning model that performs facial authentication by determining whether or not a person is the same person in an image. For these, the original image is needed.

In such cases, original images on which processing to conceal the personal information has not been executed need to be used in the machine learning, but it is difficult to use the original images in machine learning from the perspective of protecting personal information.

### SUMMARY OF THE INVENTION

In light of the problems described above, the present invention enables realization of technology for using original images in machine learning while protecting personal information.

According to one aspect of the present invention, there is provided an information processing apparatus comprising: a determining unit configured to determine a concealed region for concealing personal information in a first image; a concealing unit configured to execute concealing processing on the first image on a basis of the concealed region; an applying unit configured to apply label information to the concealed region; a display unit configured to display the label information superimposed on a second image, which is a concealed image obtained by executing the concealing processing; and a training unit configured to perform training using the first image.

Further features of the present invention will become apparent from the following description of exemplary embodiments (with reference to the attached drawings).

### BRIEF DESCRIPTION OF THE DRAWINGS

FIG. 1 is a diagram illustrating an example of the hardware configuration of an information processing apparatus according to an embodiment.

FIG. 2 is a diagram illustrating an example of the software configuration of an information processing apparatus according to an embodiment.

FIGS. 3A to 3C are diagrams for describing the detailed configuration of an information processing apparatus according to a second, third, and fourth embodiment.

FIGS. 4A to 4F are diagrams for describing a first embodiment.

FIGS. 5A and 5B are flowcharts illustrating the process of image registration processing according to the first embodiment.

FIG. 6 is a flowchart illustrating the process of training processing according to an embodiment.

FIGS. 7A and 7B are flowcharts illustrating the process of display screen generation processing according to the first embodiment.

FIG. 8 is a diagram for describing the second embodiment.

FIGS. 9A to 9D are flowcharts illustrating the process of display screen generation processing according to the second embodiment.

FIG. 10 is a diagram for describing the third embodiment.

FIGS. 11A and 11B are flowcharts illustrating the process of display screen generation processing according to the third embodiment.

FIG. 12 is a diagram for describing the fourth embodiment.

FIGS. 13A and 13B are flowcharts illustrating the process of output map confirmation processing according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment: Display with Superimposed Label Information

In the present embodiment, an example is described that uses original images as the images used in training but displays concealed images to the user performing the training. For example, in the example described below, label information (face label, eye label, mouth label, category label, gender label, orientation label, and the like) is displayed on a concealed image or together with a concealed image.

### Hardware Configuration

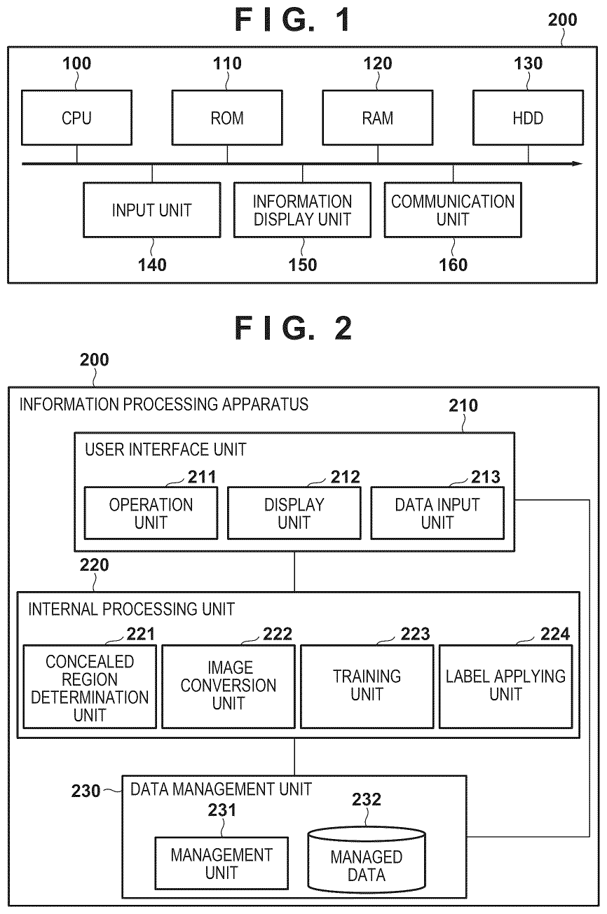

FIG. 1 is a diagram illustrating an example of the hardware configuration of an information processing apparatus according to an embodiment. An information processing apparatus 200 includes a central processing unit (CPU) 100, a read-only memory (ROM) 110, a random-access memory (RAM) 120, and a HDD 130. Also, the information processing apparatus 200 further includes an input unit 140, an information display unit 150, and a communication unit 160.

The CPU 100 is a central processing unit that performs arithmetic and logic operations and logic determination for various types of processing. A control program is stored in the ROM 110. The RAM 120 is a main memory of the CPU 100 and is used as a temporary storage area such as a working area. The HDD 130 is a hard disk for storing electronic data and programs relating to the present embodiment. An external storage apparatus may be used to achieve a similar function. Here, an external storage apparatus, for example, can be implemented by media (a storage medium) and an external storage drive for implementing access to the media. Known examples of such media include a flexible disk (FD), a CD-ROM, a DVD, USB memory, MO, flash memory, and the like. Also, the external storage apparatus may be a server apparatus or the like connected on a network.

The input unit 140 is constituted by a keyboard, touch panel, or the like and is configured to receive an input from a user. The information display unit 150 is constituted by a liquid crystal display or the like and can display various types of data and processing results to the user. Also, the information processing apparatus 200 can communicate with other apparatuses via the communication unit 160. An instruction from a user may be received via the communication unit 160 from another apparatus, and a processing result may be output to another apparatus.

### Software Configuration

FIG. 2 is a diagram illustrating an example of the software configuration of an information processing apparatus according to an embodiment. The information processing apparatus 200 includes a user interface unit 210 for input and output with respect to the user via the input unit 140, an internal processing unit 220 that executes internal processing of the information processing apparatus 200, and a data management unit 230 that registers and manages input data. Note that only an overview will be given, and details will be described later.

The user interface unit 210 includes an operation unit 211, a display unit 212, and a data input unit 213. The operation unit 211 receives mouse and/or keyboard operations from a user and selects an image to register in the data management unit 230 and/or an image for training at a training unit 223. The display unit 212 displays an image to register in the data management unit 230 and/or an image for training at the training unit 223 and allows the user to visually confirm data. The data input unit 213 receives input data such as captured image data and the like. This includes, for example, images obtained from an image capture apparatus such as a digital camera, a surveillance camera, and the like.

The internal processing unit 220 includes a concealed region determination unit 221, an image conversion unit 222, the training unit 223, and a label applying unit 224.

The concealed region determination unit 221 determines a region for concealing personal information in image data input from the data input unit 213. The concealed region may be determined by user input via the operation unit 211. The image conversion unit 222 performs image conversion based on the concealed region determined by the concealed region determination unit 221 and conceals the personal information. The training unit 223 executes machine learning using training data held by the data management unit 230. In the example described, a human face detector is the target of machine learning according to the present embodiment. The detector may be convolutional neural networks or a vision transformer (ViT). Alternatively, a support vector machine (SVM) combined with a feature detector may be used, and various models can be used. The present embodiment is not limited to the formats described above, and in the present embodiment described below, the face detector is a CNN. The label applying unit 224 applies a label to the data input from the data input unit 213. Labels may be applied by user input via the operation unit 211.

The data management unit 230 includes a management unit 231 and managed data 232. The management unit 231 registers data input from the data input unit 213 and data processed by the internal processing unit 220. The managed data 232 indicates a data group held by the data management unit 230 and includes training data input from the data input unit 213, concealed region information determined by the concealed region determination unit 221, a learning model generated by the training unit 223, and the like.

### Processing Overview

In the example according to the present embodiment described below, after a user A registers their own images in the data management unit 230, user B uses the images registered by the user A to perform machine learning.

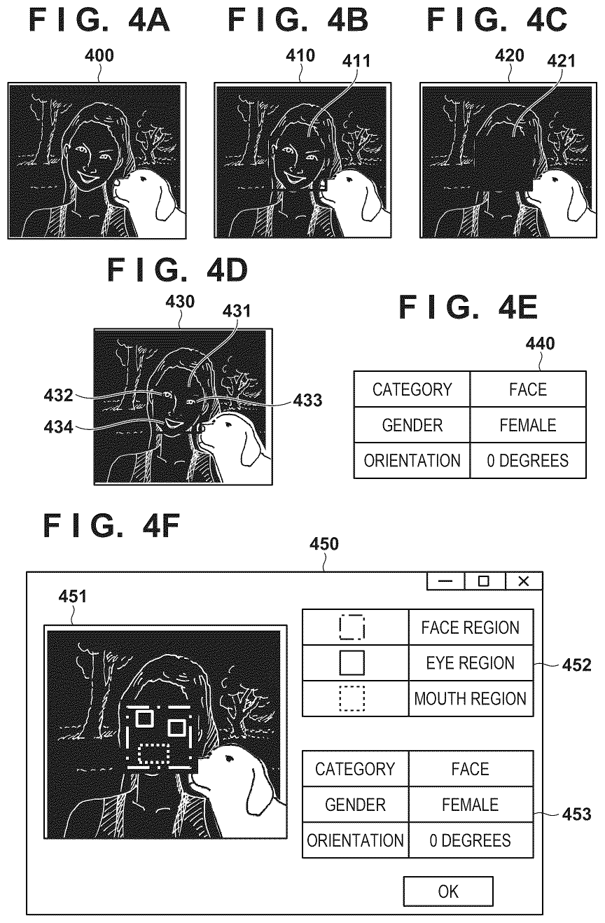

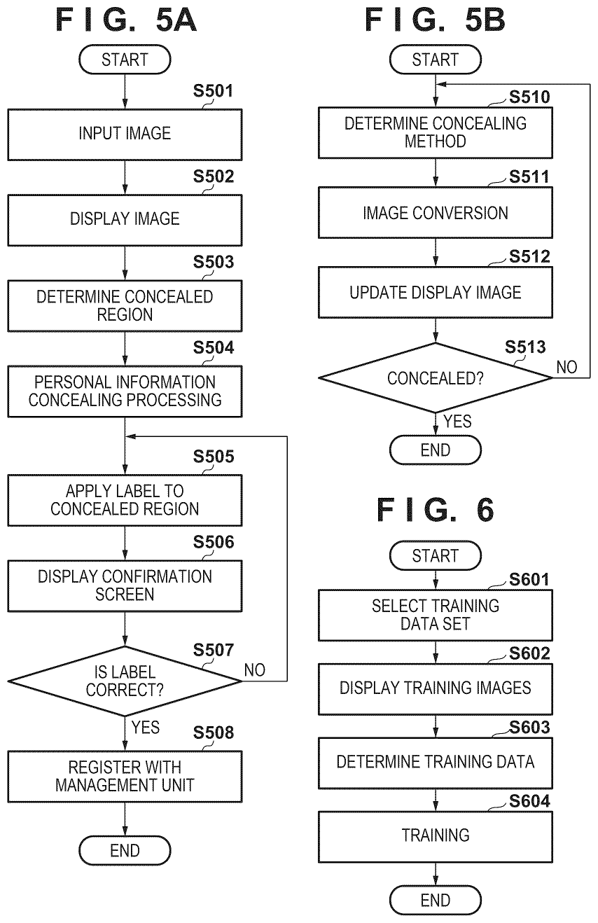

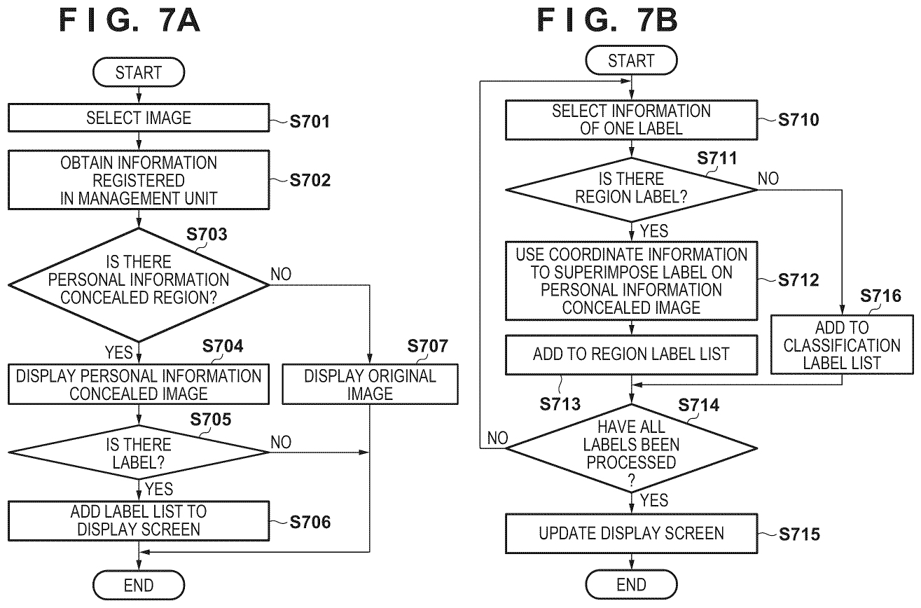

FIGS. 4A to 4F illustrate images showing a person and a dog as an example of an image according to the present embodiment. Also, FIGS. 5A and 5B are flowcharts illustrating the process of image registration processing according to the present embodiment. FIG. 6 is a flowchart illustrating the process of learning processing according to the present embodiment. FIGS. 7A and 7B are flowcharts illustrating the process of generation processing for images to be displayed when confirming training images according to the present embodiment. Each item of processing of the flowcharts described below are implemented by the CPU 100 executing a control program.

### Image Registration Processing

First, a method of registering images by the user A will be described with reference to the flowcharts of FIGS. 5A and 5B. In step S501, the data input unit 213 receives an input of an image from the user A. For example, the user A inputs an image 400 illustrated in FIG. 4A. In step S502, the display unit 212 displays the image 400 to the user A.

In step S503, the concealed region determination unit 221 determines a concealed region in the image 400 on the basis of a mouse operation by the user A. A concealed region 411 indicated in image 410 of FIG. 4B is determined via the operation by the user A. In the example according to the present embodiment described below, the user A performs an operation to designate a region in the image 400 displayed on the display unit 212. However, no such limitation is intended. For example, the concealed region determination unit 221 may automatically determine a concealed region using a trained model held by the data management unit 230. In a case such as in FIG. 4B where a human face region is set as the concealed region, a face detector can be used as a trained model.

In step S504, the image conversion unit 222 executes personal information concealing processing. FIG. 5B is a flowchart illustrating a detailed process of the personal information concealing processing. In step S510, the image conversion unit 222 determines the method for concealing the personal information. The concealing method according to the present embodiment is determined to be blanking out processing by a designation from the user A. However, no such limitation is intended. For example, any method such as blurring processing or conversion to similar image processing can be used as long as the image conversion processing can conceal personal information.

In step S511, the image conversion unit 222 performs image conversion of the image 400 using the concealing method determined in step S510. For example, as can be seen in FIG. 4C, a personal information concealed image 420 is generated with a concealed region 421 blanked out. In the present embodiment, image conversion is performed only on the concealed region. However, image conversion may be performed on a region of any size as long as the region is determined on the basis of the concealed region. For example, a region with a size that is a predetermined multiple of the size of the concealed region may be blanked out.

In step S512, the display unit 212 displays the generated personal information concealed image 420. Thereafter, in step S513, the display unit 212 notifies the user A (for example, displays a Yes/No button), prompting the user A to confirm whether or not the personal information has been concealed in the personal information concealed image 420. If the user A determines that the personal information has been concealed, for example, the personal information concealing processing ends in response to the user A pressing the Yes button. On the other hand, if the user A determines that the personal information has not been concealed, for example, in response to the user A pressing the No button, the processing returns to step S510 and a concealing method is determined again. In the present embodiment, it is assumed that it is determined that the personal information is concealed by the personal information concealed image 420, and the personal information concealing processing ends. Thereafter, the processing proceeds to step S505.

In step S505, the label applying unit 224 applies a label onto the concealed region. In the present embodiment, the label is applied automatically, but no such limitation is intended. The user A may use the operation unit 211 to manually apply a label to the concealed region, and a label may be applied to regions other than the concealed region. FIGS. 4D and 4E illustrate applied label information. A label-applied image 430 illustrated in FIG. 4D has an applied region label and is applied with a face label 431, eye labels 432 and 433, and a mouth label 434. Label information 440 illustrated in FIG. 4E indicate the concealed region classification labels, with face being applied as a category label, female being applied as a gender label, and 0 degrees being applied as an orientation label. Here, a label is also applied to the concealed region 411, and a human face label, which is a label of the same type as the face label 431, is applied.

In step S506, the display unit 212 displays a confirmation screen. For example, the information of FIGS. 4D and 4E is displayed. Thereafter, in step S507, the display unit 212 allows the user A to confirm whether or not the applied label information is correct. If the label information is correct based on an answer input by the user, the processing proceeds to step S508. On the other hand, if the label information is incorrect, the processing returns to step S505, and a label is applied again. In the present embodiment, it is assumed that the label information is all correct, and thus the processing proceeds to step S508.

In step S508, the management unit 231 stores, as the managed data 232, the image 400, concealed region information indicating the concealing method and the coordinates and size of the concealed region, the personal information concealed image 420, label information, and the like. In this manner, the image registration processing by the user A ends.

Processing for Machine Learning Using Original Images while Concealing Personal Information

Next, a training method using original images while concealing personal information used in the process of the user B executing machine learning will be described with reference to the flowchart of FIG. 6.

In step S601, the training unit 223 selects a training data set on the basis of an operation of the operation unit 211 by the user B. Here, the training data set is an image data set possessed in advance as the managed data 232. In the training data set, the image 400 illustrated in FIG. 4A and the label information are included.

In step S602, the display unit 212 displays training images for confirming the images to use in training before the machine learning is executed. Here, FIG. 7A illustrates a detailed flowchart relating to image display in a case where the user B selects the image 400 as an image to display.

In step S701, the training unit 223 selects, as a display image, the image 400 selected by the user B by receiving an operation of the operation unit 211 by the user B. In step S702, the training unit 223 obtains the information of the image 400 from the management unit 231. In step S703, the training unit 223 performs confirmation of whether or not a personal information concealed region is applied to the image 400. In a case where Yes is true for the present step, the processing proceeds to step S704. On the other hand, in a case where No is true for the present step, the processing proceeds to step S707. In the present embodiment, as the personal information concealed region is applied to the image 400, the processing proceeds to step S704.

In step S704, the display unit 212 displays the personal information concealed image 420 obtained from the management unit 231 on the display screen. Note that in the example according to the present embodiment described here, the personal information concealed image 420 is obtained from the management unit 231, but no such limitation is intended. For example, the personal information concealed image 420 may not be stored in the management unit 231, and the personal information concealed image 420 may be generated using the image 400 and the concealed region information.

In step S705, the training unit 223 determines whether the label information is applied to the image 400. In a case where Yes is true for the present step, the processing proceeds to step S706. On the other hand, in a case where No is true for the present step, the processing ends. In the present embodiment, as the label information is applied, the processing proceeds to step S706. In step S706, the training unit 223 adds a label list to the display screen. The processing of step S706 will be described below in detail with reference to FIG. 7B. In step S707, the display unit 212 displays the image 400, which is the original image, as there is no personal information concealed region. This is the sequence of processing of FIG. 7A.

Next, the processing of step S706 will be described in detail with reference to the flowchart of FIG. 7B.

In step S710, the training unit 223 selects one piece of information from the applied label information on the basis of an operation of the operation unit 211 by the user B. In the present embodiment, it is assumed that the face label 431 is selected first.

In step S711, the training unit 223 determines whether or not the selected label information is a region label. In a case where the training unit 223 determines Yes for the present step, the processing proceeds to step S712. On the other hand, in a case where No is true for the present step, the processing proceeds to step S716. As the face label 431 selected in step S710 is a label indicating a region in the image and coordinate information is included, the processing proceeds to step S712.

In step S712, the training unit 223 superimposes the label on the personal information concealed image 420 using the coordinate information. In step S713, the training unit 223 adds the label information to the region label list. Here, the region label list is a list of label information superimposed on the personal information concealed image 420 and is information displayed on the screen when the display screen is updated in step S715. The details will be described below. Here, the label information of the face label 431 is added to the region label list.

In step S714, the training unit 223 determines whether or not all of the labels applied to the image 400 has been processed. In a case where Yes is true for the present step, the processing proceeds to step S715. On the other hand, in a case where No is true for the present step, the processing returns to step S710. Here, as there is still a label that has not been processed, the processing returns to step S710 and continues.

Next, it is assumed that, in step S710, the training unit 223 selects a category label on the basis of an operation of the operation unit 211 by the user B. In this case, in the determination processing of Step S711, as the category label is a classification label applied to the concealed region and the selected label does not include coordinate information, the processing proceeds to step S716.

In step S716, the training unit 223 adds the information of the category label to the classification label list. Here, the classification label list is a list of label information applied to the concealed region and is information displayed on the screen when the display screen is updated in step S715. The details will be described below. Thereafter, the processing proceeds to step S714, and whether or not all of the labels applied to the image 400 have been processed is determined. Here, as there is still label information that has not been processed, the processing returns to step S710 and continues similar processing.

By executing processing in this order to apply labels in this manner, the region labels are superimposed on the personal information concealed image 420 and added to the region label list and the classification labels are added to the classification label list. After all of the label processing has ended, the processing proceeds to step S715.

In step S715, the display unit 212 updates the display screen. Here, FIG. 4F illustrates an example of a display screen 450 displayed to the user B after all of the processing according to the present embodiment has ended. A display image 451 is superimposed with a region label, and information indicating the region labels is listed in a region label list 452. In the illustrated example, the face region is indicated by a dot-dash line, the eye region is indicated by a solid line, and a mouth region is indicated by a broken line. In this manner, even if the original image of the personal information concealed image cannot be seen due to personal information protection, at what position the labels are applied can be visually confirmed. Also, classification label information of concealed regions is listed in a classification label list 453. In the illustrated example, it can be seen that the category is face, the gender is female, and the orientation is 0 degrees (front on). Accordingly, the user B can know what kind of image the image is without looking at the original image. When the processing of step S715 ends, the processing of step S706 ends and the processing of step S602 also ends.

Thereafter, in step S603 of FIG. 6, the training unit 223 determines the training data on the basis of an operation of the operation unit 211 by the user B. In step S604, the training unit 223 executes machine learning. This ends the processing of FIG. 6.

As described above, in the present embodiment, the image data is managed by the management unit 231, the image 400 is used in the machine learning, and the personal information concealed image 420 is used when displaying to user B performing the training.

Accordingly, machine learning can be executed using original images while concealing personal information. Also, since labels are superimposed on personal information concealed images, the user B who cannot know the original image can visually recognize the information of the original image and can support the determination of whether or not to use the personal information concealed image in training.

### Second Embodiment: Display of Similar Images

In the present embodiment, an example is described that uses original images as the images used in training but displays concealed images to the user performing the training. More specifically, in the example described below, similar images (in other words, modified concealed images) similar to concealed regions are displayed.

In the example according to the present embodiment described here, the image 400 illustrated in FIG. 4A showing a person and a dog as in the first embodiment is registered in the data management unit 230 by the user A, and an image similar to the concealed region 411 illustrated in FIG. 4B is displayed on the display screen.

The hardware configuration of the information processing apparatus 200 according to the present embodiment is similar to the configuration illustrated in FIG. 1 of the first embodiment. The software configuration is also similar to that of the first embodiment regarding the user interface unit 210 and the data management unit 230, but the internal processing unit configuration is different.

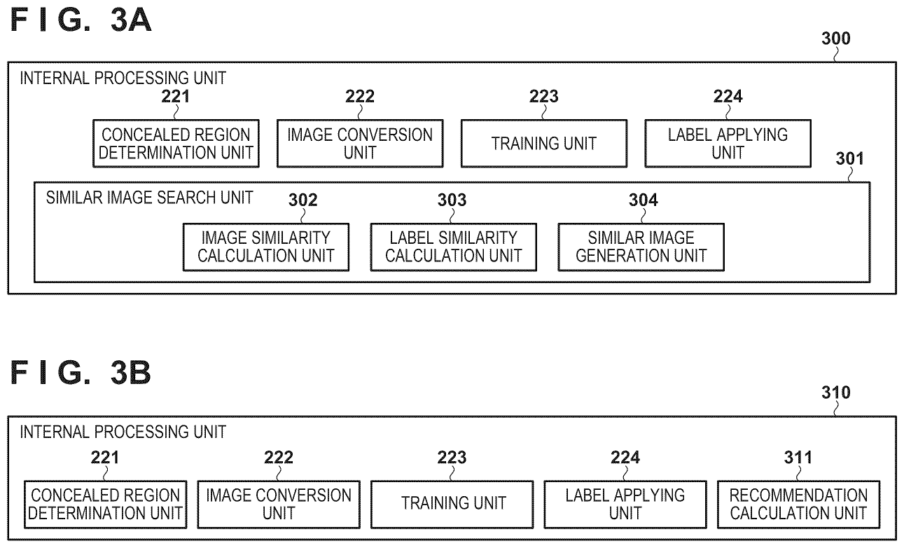

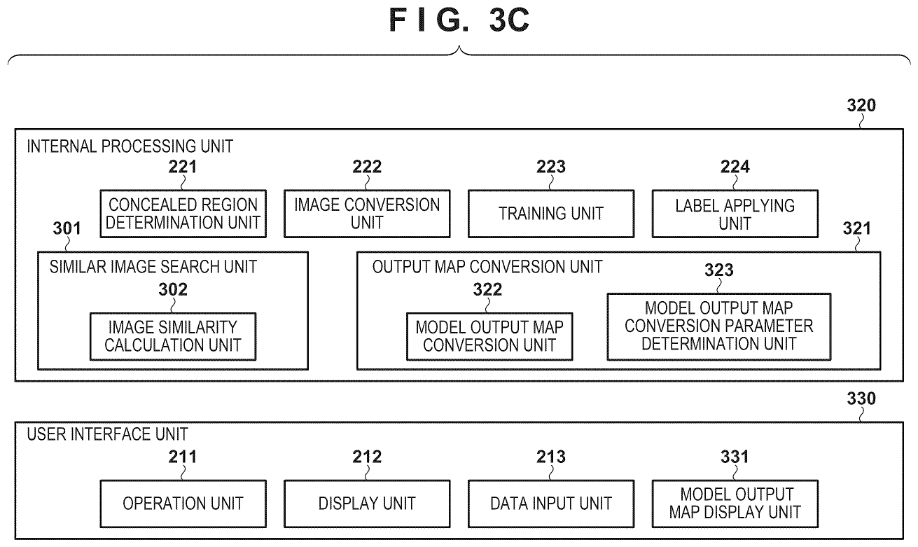

FIG. 3A illustrates an example of an internal processing unit 300 according to the present embodiment. In the present embodiment, the internal processing unit 300, in addition to the components illustrated in the first embodiment, further includes a similar image search unit 301 for displaying similar images. The similar image search unit 301 includes an image similarity calculation unit 302, a label similarity calculation unit 303, and a similar image generation unit 304.

In an example according to the present embodiment described here, the processing of FIGS. 7A and 7B described in the first embodiment ends, and from a state in which the display screen 450 illustrated in FIG. 4F is displayed, the user B displays a similar image to confirm the image to use in training.

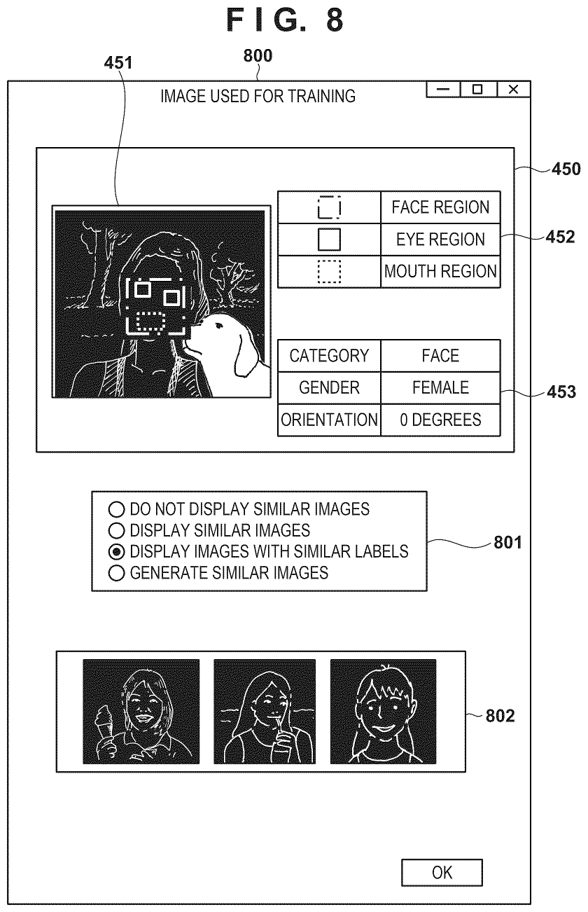

FIG. 8 is a diagram illustrating an example of a display screen in a case where a similar image is displayed according to the present embodiment. A display screen 800 is an example of a display screen after the processing according to the present embodiment is executed. A search method selection box 801 can be used to select whether or not to display a similar image and the similar image search method if displaying a similar image. In the illustrated example, the example options given as “Do not display similar images”, “Display similar images”, “Display images with similar labels”, and “Generate similar image”. First, the case of processing when “Display similar images” is selected in the search method selection box 801 will be described.

Processing to Display Similar Image with High Image Similarity

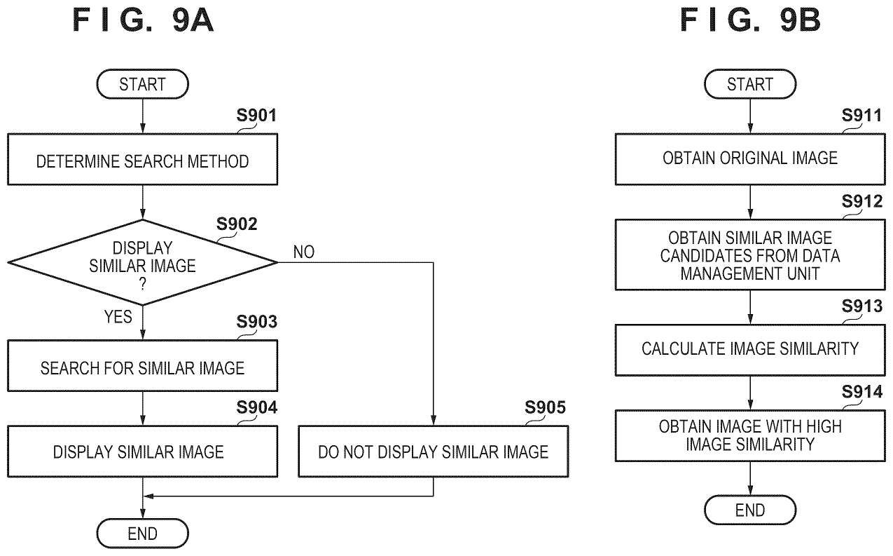

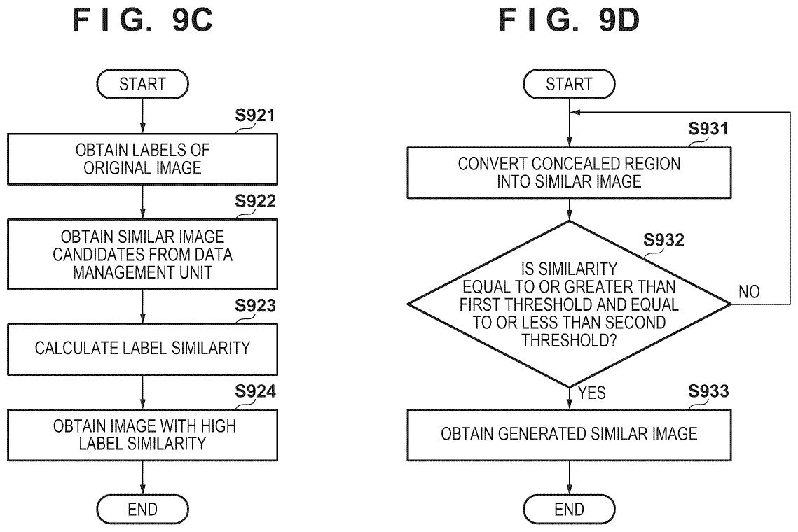

FIGS. 9A and 9B are flowcharts illustrating the process of processing to search for a similar image according to the present embodiment.

In step S901, the similar image search unit 301 determines a search method on the basis of input from the user B. Here, “Display a similar image” is selected in the search method selection box 801 by the user B. Thus, it is determined to search for an image with a high (equal to or greater than a predetermined value) image similarity using the image similarity calculation unit 302.

Here, image similarity is calculated as the similarity between images by converting the brightness and color distribution in an image, the position information of an object, edge information, and the like into numerical values. In the present embodiment, a trained model held by the data management unit 230 is used to perform a feature amount extraction of the image to compare similarity. However, no such limitation is intended. For example, a method of comparing both images unchanged may be used.

In step S902, the similar image search unit 301 determines whether or not to display a similar image. In a case where Yes is true for the present step, the processing proceeds to step S903. On the other hand, in a case where No is true for the present step, the processing proceeds to step S905. For example, in a case where “Do not display similar image” is selected in the search method selection box 801, the processing proceeds to step S905 and a similar image is not displayed. Here, it is assumed that “Display similar images” is selected, and the processing proceeds to step S903.

In step S903, the similar image search unit 301 searches for a similar image. Here, the flowchart of FIG. 9B illustrates the processing of step S903 in detail. In step S911, the similar image search unit 301 obtains the original image. Here, the image 400 illustrated in FIG. 4A is obtained.

In step S912, the similar image search unit 301 obtains images with a human face label applied and no personal information concealed regions as candidates for an image to display as a similar image from the managed data 232 held by the data management unit 230. Here, as in the first embodiment, a human face label is applied to the concealed region 411 (FIG. 4B). Thus, it can be seen that the image with a human face label is suitable as an image to display as a similar image. Also, in step S912, to obtain a candidate for an image to display as a similar image, an image with no personal information concealed regions that can be displayed to the user B is obtained.

In step S913, the image similarity calculation unit 302 calculates the image similarity. For example, the image similarity between the concealed region 411 illustrated in FIG. 4B and each human face region of the image group obtained in step S912 is calculated. Note that in the present embodiment, image similarity is calculated for the concealed region. However, no such limitation is intended. For example, the image similarity of any region may be used including image similarity of the entire image, image similarity of a region determined as a reference for a concealed region, and the like.

In step S914, the similar image search unit 301 obtains an image with a high (equal to or greater than a predetermined value) similarity calculated by the image similarity calculation unit 302. This ends the processing of FIG. 9B. Thereafter, the processing proceeds to step S904.

In step S904, the display unit 212 displays a similar image. For example, an image with a human face region similar to the concealed region of the image 400 illustrated in FIG. 4A is displayed in a similar image display portion 802 (FIG. 8) as a similar image. In step S905, the display unit 212 does not display a similar image. This ends the sequence of processing of FIG. 9A.

Processing to Display Similar Image with High Label Similarity

Next, the case of processing when “Display an image with a similar label” is selected in the search method selection box 801 of FIG. 8 will be described.

In step S901, in a case where “Display an image with a similar label” is selected in the search method selection box 801 of FIG. 8 by the user B, it is determined to search for an image with a high label similarity using the label similarity calculation unit 303.

Here, label similarity is obtained by converting how much the label information in two images matches into a numerical value, with a higher similarity indicating a better label match. In the present embodiment, the similarity is calculated so that the similarity increases the more the labels match. However, no such limitation is intended. For example, weighting may be applied to the types of labels when calculating the similarity.

In step S902, it is determined whether or not to display a similar image. Here, it is assumed that “Display an image with a similar label” is selected, and the processing proceeds to step S903. Here, the process of the processing of step S903 when “Display an image with a similar label” is selected in the search method selection box 801 of FIG. 8 will be described in detail with reference to the flowchart of FIG. 9C.

In step S921, the label similarity calculation unit 303 obtains the labels of the original image. Here, the labels of the image 400 of FIG. 4A, which is the original image, are obtained. In step S922, the label similarity calculation unit 303 obtains candidates for an image to display as a similar image from the managed data 232 held by the data management unit 230. Here, an image with a human face label applied and no personal information concealed regions is obtained.

In step S923, the label similarity calculation unit 303 calculates the label similarity. Here, the label similarity between the concealed region 411 illustrated in FIG. 4B and each human face region of the image group obtained in step S922 is calculated. Here, the label similarity in a concealed region is calculated. However, no such limitation is intended. For example, the label similarity of any region may be used including label similarity of the entire image, label similarity of a region determined as a reference for a concealed region, and the like.

In step S924, the similar image search unit 301 obtains an image with high (equal to or greater than a predetermined value) label similarity on the basis of the label similarity calculated by the label similarity calculation unit 303. This ends the processing of FIG. 9C. Thereafter, the processing proceeds to step S904.

In step S904, the display unit 212 displays a similar image. For example, an image with a human face region similar in terms of the concealed region of the image 400 illustrated in FIG. 4A and label is displayed in the similar image display portion 802 (FIG. 8) as a similar image.

### Processing to Generate and Display Similar Image

Lastly, the case of processing when “Generate similar image” is selected in the search method selection box 801 will be described.

In step S901, in a case where “Generate similar image” is selected in the search method selection box 801 of FIG. 8 by the user B, it is determined to generate an image with high similarity using the similar image generation unit 304. Also, in the present embodiment, generating a similar image means generating a similar image using generative artificial intelligence.

In step S902, it is determined whether or not to display a similar image. Here, it is assumed that “Generate similar image” is selected, and the processing proceeds to step S903. Here, the process of the processing of step S903 when “Generate similar image” is selected in the search method selection box 801 of FIG. 8 will be described in detail with reference to the flowchart of FIG. 9D.

In step S931, the similar image generation unit 304 converts the concealed region into a similar image. Here, the concealed region 411 illustrated in FIG. 4B is converted into a similar image. Note that in this example, the concealed region is converted into a similar image. However, no such limitation is intended. For example, the conversion to a similar image may be performed on any region including an image overall region, a region determined as a reference for a concealed region, and the like.

In step S932, the image similarity calculation unit 302 determines whether or not the similarity between the generated similar image and the original image is equal to or greater than a first threshold and equal to or less than a second threshold. Focusing on concealing the personal information as the purpose, a lower similarity between the generated similar image and the original image means that the personal information is better concealed. However, if an image that is not similar to displayed as a similar image, the user B may falsely think that the image is not of the original image. Regarding this, in the present embodiment, the first threshold is set to 0.2 and the second threshold is set to 0.8. Thus, by determining whether or not the similarity between the generated similar image and the original image is equal to or greater than the first threshold and equal to or less than the second threshold, it can be determined whether or not the similar image is too dissimilar. Here, in a case where the similarity is too low (similarity<first threshold) or too high (similarity>second threshold), the processing of step S931 is executed again. In a case where an image with a similarity equal to or greater than the first threshold and equal to or less than the second threshold is generated, the processing proceeds to step S933.

In step S933, the similar image search unit 301 obtains an image generated by the similar image generation unit 304. This ends the processing of FIG. 9D. Thereafter, the processing proceeds to step S904.

In step S904, the display unit 212 displays a similar image. For example, the generated image is displayed in the similar image display portion 802 (FIG. 8) as a similar image.

As described above, in the present embodiment, an image similar to the concealed region can be displayed and the user B who cannot know the original image can be visually supported. Also, support can be given to determining whether or not to use the personal information concealed image in training. This improves the user-friendliness for the user.

### Third Embodiment: Display of Training Use Recommendation

In the present embodiment, an example is described that uses original images as the images used in training but displays concealed images to the user performing the training. Also, an example of displaying training use information and a training use recommendation score at this time will be described.

In the example according to the present embodiment described here, the image 400 illustrated in FIG. 4A, which is an image showing a person and a dog is registered in the data management unit 230 by the user A as in the first embodiment and training use information and a training use recommendation score for the image 400 is displayed on the display screen.

Here, the training use information is information associated with the original image that can include at least one of an accuracy improvement rate per task when the image is used in training by another user, the number of times used in training, the number of high rating, and the like. The number of high ratings refers to the number of users that use the target image in training and evaluate the image as having enhanced the training by using it. The training use recommendation score is a score obtained in accordance with Formula (1), with higher scores indicating that the image is more highly recommended for training.

$$\begin{matrix}Math . 1 & \\ {S}_{f} = {R}_{f} {W}_{{R}_{f}} + {U}_{f} {W}_{{U}_{f}} + {G}_{f} {W}_{{G}_{f}} & ( 1 )\end{matrix}$$

Here, S_{f} is the training use recommendation score for a human face, and R_{f} is the average value of the accuracy improvement rate of the human face detection rate when the image 400 is used in training by another user. Also, U_{f} is the number of times the image 400 is used in training human face detection by another user, and G_{f} is the number of high ratings of the image 400. Also, W_{Rf}, W_{Uf}, and W_{Gf} are weight coefficients, with weight coefficient being able to be determined per image and per training task. In the present embodiment described herein, W_{Rf}=0.02, W_{Uf}=0.00005, and W_{Gf}=0.0002.

The hardware configuration example of the information processing apparatus 200 according to the present embodiment is similar to the configuration illustrated in FIG. 1 of the first embodiment. The software configuration is also similar to that of the first embodiment regarding the user interface unit 210 and the data management unit 230, but the internal processing unit configuration is different.

FIG. 3B illustrates an example of an internal processing unit 310 according to the present embodiment. In the present embodiment, the internal processing unit 310, in addition to the components illustrated in the first embodiment, further include a recommendation calculation unit 311 for calculating a training use recommendation.

In an example according to the present embodiment described here, the processing of FIGS. 7A and 7B described in the first embodiment ends, and from a state in which the display screen 450 illustrated in FIG. 4F is displayed, the user B displays the training use information and the training use recommendation to confirm the quality of the image to use in training.

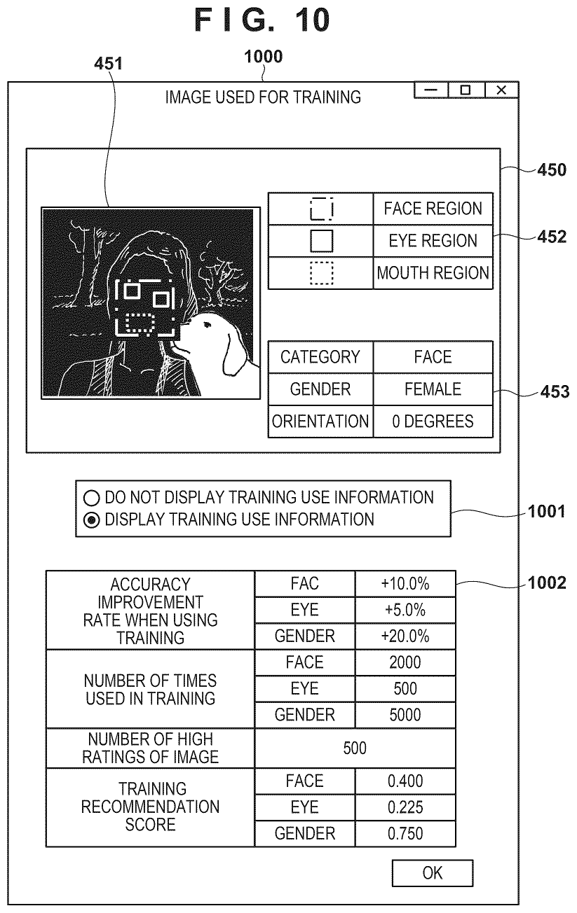

FIG. 10 is a diagram illustrating an example of a display screen in a case where the training use information and the training use recommendation are displayed according to the present embodiment. A display screen 1000 is an example of a display screen after the processing according to the present embodiment is executed. A training use information display selection box 1001 can be used to select whether or not to display training use information. In the example according to the present embodiment described here, “Display training use information” is selected in the training use information display selection box 1001.

### Display Processing for Training Use Information

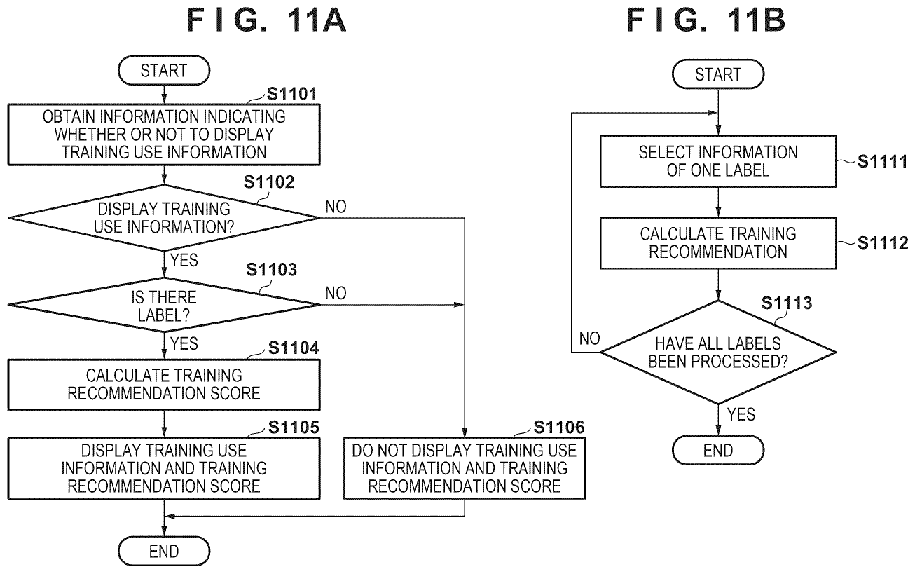

FIGS. 11A and 11B are flowcharts illustrating processes of the processing to display the training use information and the training use recommendation according to the present embodiment. In step S1101, the internal processing unit 310 obtains information indicating whether or not to display the training use information on the basis of an input from the user B. In step S1102, the internal processing unit 310 determines whether or not to display the training use information on the basis of the information obtained in step S1101. In a case where Yes is true for the present step, the processing proceeds to step S1103. On the other hand, in a case where No is true for the present step, the processing proceeds to step S1106. Specifically, in a case where “Do not display training use information” is selected in the training use information display selection box 1001, the processing proceeds to step S1106 and the training use information is not displayed. Here, it is assumed that “Display training use information” is selected, and the processing proceeds to step S1103.

In step S1103, the internal processing unit 310 determines whether or not to apply a label to the image (for example, the image 400). In a case where Yes is true for the present step, the processing proceeds to step S1104. On the other hand, in a case where No is true for the present step, the processing proceeds to step S1106. Here, as a label is applied to the image 400, the processing proceeds to step S1104.

In step S1104, the recommendation calculation unit 311 calculates the training use recommendation score. FIG. 11B is a flowchart illustrating the processing of step S1104 in detail. In step S1111, the recommendation calculation unit 311 selects one from among the applied labels. In the present embodiment, the face label 431 is selected first. In step S1112, the recommendation calculation unit 311 calculates the training use recommendation score. The recommendation calculation unit 311 calculates the training use recommendation score of the face label using training use information 1002 illustrated in FIG. 10 (accuracy improvement rate=10, number of times used in training=2000, number of high ratings=500) and Formula (1). Here, 10×0.02+2000×0.00005+500×0.0002=0.4. In step S1113, the recommendation calculation unit 311 determines whether or not all of the labels applied to the image (for example, the image 400) have been processed. In a case where Yes is true for the present step, the processing ends. On the other hand, in a case where No is true for the present step, the processing returns to step S1111. Here, as there is still a label that has not been processed, the processing returns to step S1111 and continues.

As described above, by processing the applied labels in order, a training use recommendation score for all of the labels can be calculated. After all of the label processing has ended, the processing proceeds to step S1105.

In step S1105, the display unit 212 displays the training use information and the training use recommendation. In the training use information 1002 of FIG. 10, for example, training use information (accuracy improvement rate, number of times used in training, and number of high ratings) for a face label, an eye label, and a gender label and training use recommendation scores are listed. In FIG. 10, for example, a score of 0.4 calculated for a face label and the like are displayed. In step S1106, the display unit 212 does not display the training use information and the training use recommendation score. This ends the processing of FIG. 11A.

As described above, in the present embodiment, the training use information and the training use recommendation score can be displayed, and the user B who cannot know the original image can be supported. Also, support can be given to determining whether or not to use the personal information concealed image in training. This improves the user-friendliness for the user.

### Fourth Embodiment: Display of Training Status

According to the first to third embodiment described above, machine learning can be performed using original images while concealing personal information. However, in machine learning using original images, it is difficult to confirm the training status of the machine learning while concealing personal information. Regarding this, the method according to the present embodiment described here can conceal personal information, even in a case where the training status of machine learning using original images is confirmed.

The hardware configuration of the information processing apparatus 200 according to the present embodiment is similar to the configuration illustrated in FIG. 1 of the first embodiment. The software configuration is also similar to that of the first embodiment regarding the data management unit 230, but the configuration of the internal processing unit and the user interface unit is different.

FIG. 3C illustrates an example of an internal processing unit 320 and a user interface unit 330 according to the present embodiment. The internal processing unit 320, in addition to the components of the first embodiment, further includes the similar image search unit 301 and an output map conversion unit 321.

The similar image search unit 301 includes the image similarity calculation unit 302. The output map conversion unit 321 includes a model output map conversion unit 322 and a model output map conversion parameter determination unit 323. Also, the user interface unit 330, in addition to the components of the first embodiment, further includes a model output map display unit 331.

In the example according to the present embodiment described here, when determination of training data in step S603 of FIG. 6 ends and machine learning is performed in step S604, an output map obtained in training is displayed while concealing personal information.

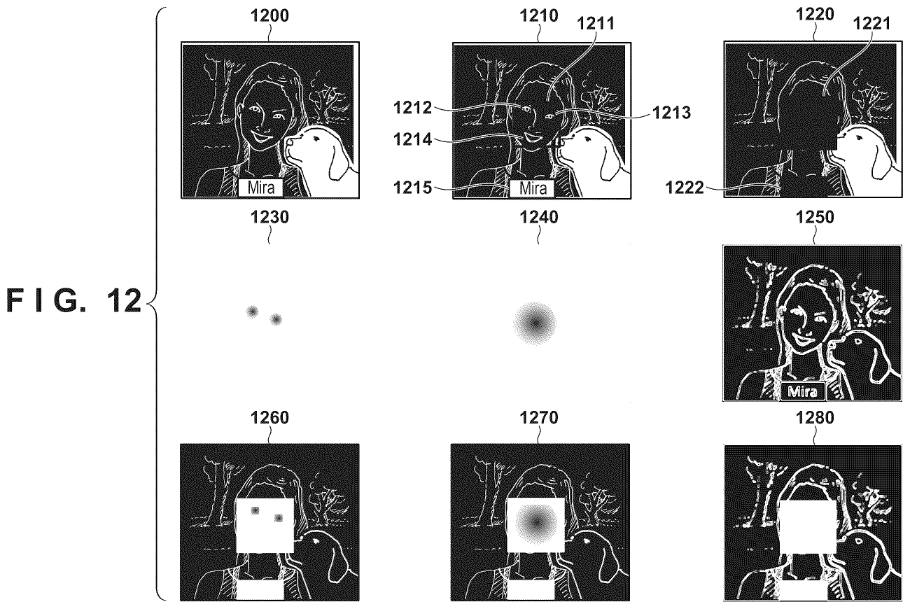

FIG. 12 illustrates an image for describing a method for confirming the training status according to the present embodiment. An image 1200 represents a training image to be used in the present embodiment. The image shows a person and a dog, and the person has a nameplate showing their name hanging from their neck. A label-applied image 1210 shows applied region labels, the region labels including a face label 1211, eye labels 1212 and 1213, a mouth label 1214, and a nameplate label 1215. Also, a personal information concealed image 1220 is an image obtained by personal information concealing processing being executed on the image 1200 registered by the user A. The regions where the face label 1211 and the nameplate label 1215 are applied have the personal information concealed by the images being blanked out as with a concealed region 1221 and a concealed region 1222.

### Training Status Confirmation Processing

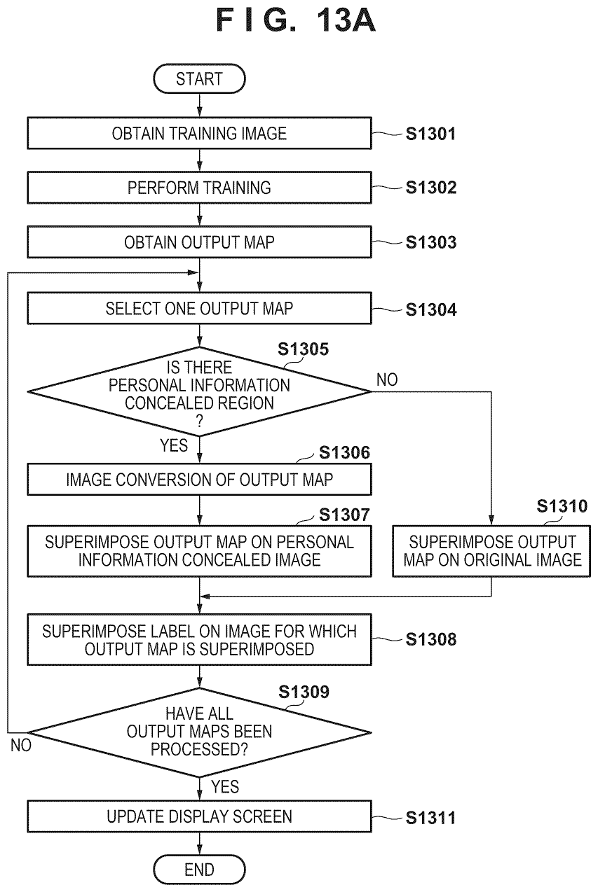

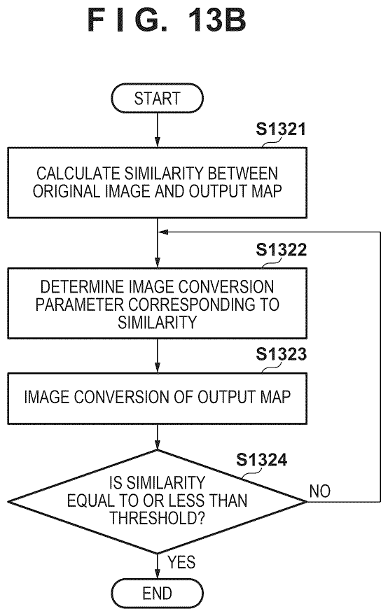

FIGS. 13A and 13B are flowcharts illustrating the processes of processing to confirm the training status according to the present embodiment. In step S1301, the internal processing unit 320 selects a training image. For example, the image 1200 is selected as the training image. In step S1302, the training unit 223 performs machine learning. In the present embodiment, the tasks targeted for training are a human face detection task and a human eye detection task. Thus, machine learning is performed using the face label 1211 and the eye labels 1212 and 1213.

In step S1303, the training unit 223 obtains a post-training-completion output map. At this time, display of the output map to the user B is not yet performed. The maps to be output include, for example, an eyes output map 1230, a face output map 1240, and a model intermediate output map 1250. Here, the eyes output map and the face output map are maps output from the final layer of the model that are output at the same size as the training image. Here, the model intermediate output map is a map output from an intermediate layer of the model that is output at the same size as the training image.

In the example according to the present embodiment described here, these three maps are output. However, no such limitation is intended. For example, other maps such as a mouth map, a head map, a category classification map, and the like may be output.

In the eyes output map 1230, a reaction can be seen at the position of both eyes, and in the face output map 1240, a reaction can be seen at the center position of the face. By displaying such output maps, whether or not training is correctly proceeding can be confirmed per task corresponding to a training target.

Here, to more accurately confirm the accuracy of the training, a method may be used in which an output map is superimposed on the image used in the training, and where the map is reacting on the image is looked at in detail. However, since the image 1200 is a personal information concealed image, the user B cannot confirm a map reaction with the output map superimposed on the image 1200. Note that if a pooling layer, an upsampling layer, or the like are included in the components forming the model, the output map may be output at a different size to the training image. In this case, either the map or the image is resized so that the two sizes are equal before superimposed display is performed.

Also, in the model intermediate output map 1250, it can be seen that much edge feature amount of the image 1200 remains. If such an output map is displayed to the user B, the user B may learn what kind of image the original image is, leading to the possibility of the personal information being leaked.

From this, it can be seen that the following problems may occur if the progress of the training of the personal information concealed image was to be confirmed. (1) The original image cannot be used as the image superimposed with the output map. (2) There is a possibility of personal information remaining in the output map. Regarding this, in the present embodiment, support is performed so that the user B can accurately learn the output map reactions even when performing training with personal information concealed images.

In step S1304, the training unit 223 selects one output map from among the output maps. In the present embodiment, first, the eyes output map 1230 is selected. In step S1305, the training unit 223 determines whether or not there is a personal information concealed region in the image 1200 in the selected output map. In a case where Yes is true for the present step, the processing proceeds to step S1306. On the other hand, in a case where No is true for the present step, the processing proceeds to step S1310. In the present embodiment, as the personal information concealed region is applied to the image 1200, the processing proceeds to step S1306.

In step S1306, the model output map conversion unit 322 performs image conversion on the output map. Here, the reason for performing image conversion on the output map is because there is a possibility that personal information remains in the output map. FIG. 13B illustrates the flow of step S1306 in detail.

In step S1321, the image similarity calculation unit 302 calculates the image similarity between the original image and the output map. For example, the image similarity between the image 1200, which is the original image, and the eyes output map 1230, which is the output map, is calculated. In the present embodiment, the image similarity of each eye region between the image 1200 and the eyes output map 1230 is calculated. Here, the eye regions refers to the regions where the eye labels 1212 and 1213 are applied in the label-applied image 1210. Also, the region used in calculating the similarity is not limited to a region where a label is applied and may be any region such as a concealed region or a region determine as a reference for a concealed region. In the present embodiment, it is assumed that the similarity of the regions where the eye labels 1212 and 1213 are applied is 0.1 and 0.15.

In step S1322, the model output map conversion parameter determination unit 323 obtains an image conversion parameter corresponding to the similarity. Also, in the example according to the present embodiment described here, in a case where the image similarity is 0.5 or greater, blanking out processing is performed. In a case where the image similarity is less than 0.5, image conversion is not performed. Also, the method for determining the image conversion parameter is not limited, and blurring or another image conversion method may be performed and the strength of the image conversion may be changed depending on the similarity.

In step S1323, the output map conversion unit 321 performs image conversion of the output map. Here, it is assumed that the similarity of the regions where the eye labels 1212 and 1213 are applied is 0.1 and 0.15. In this case, both similarities are 0.5 or less. Thus, image conversion is not performed.

Thereafter, in step S1324, the image similarity calculation unit 302 calculates the image similarity between the original image and the output map after the processing of step S1323. Here, the image similarity between the image 1200 and the eyes output map after the processing of step S1323 is calculated. Also, the image similarity calculation unit 302 determines whether or not the calculated image similarity is equal to or less than a threshold. In a case where Yes is true for the present step, the processing ends. On the other hand, in a case where No is true for the present step, the processing returns to step S1322, and determination of the image conversion parameter is performed again. Here, since the calculated image similarity is low and equal to or less than the threshold, the processing ends and returns to the processing of FIG. 13A.

In step S1307 of FIG. 13A, the output map conversion unit 321 superimposes the image-converted output map on the personal information concealed image (for example, personal information concealed image 1220 of FIG. 12).

In step S1308, the output map conversion unit 321 superimposes a label on the image with the superimposed output map. Here, it is assumed that a display image 1260 of FIG. 12 is generated by superimposing the eye labels 1212 and 1213 on the image generated in step S1307. The personal information concealed image 1220 is superimposed with the eyes output map 1230 and the eye labels 1212 and 1213. Note that in the example according to the present embodiment described above, label information corresponding to the output map used in the processing is superimposed. However, no such limitation is intended. Any kind of label information may be applied, or no label information may be applied if there is none.

In step S1309, the output map conversion unit 321 determines whether or not all of the output maps have been processed. In a case where Yes is true for the present step, the processing proceeds to step S1311. On the other hand, in a case where No is true for the present step, the processing returns to step S1304 and continues.

In step S1310, the training unit 223 superimposes the output map on the original image. In step S1311, the model output map display unit 331 updates the display screen using the generated display image and displays the generated display image to the user B. This is the sequence of processing of FIG. 13A.

Note that here it is assumed that, in step S1309, since an unprocessed output map remains, the processing returns to step S1304 and continues. It is assumed that next, in step S1304, the face output map 1240 is selected. Thereafter, the processing proceeds to step S1305 and step S1306 and the processing of FIG. 13B is executed. As with the eyes output map, it is assumed that the similarity between the image 1200 and the face output map 1240 is low. As a result, a display image 1270 of FIG. 12 is generated. As can be seen from the display image 1270, the face output map 1240 and the face label 1211 are superimposed on the personal information concealed image 1220. Thereafter, as there is still an output map that has not been processed, the processing returns to step S1304 and continues.

It is assumed that next, in step S1304, the model intermediate output map 1250 is selected. Thereafter, the processing proceeds to step S1305 and step S1306 and the processing of FIG. 13B is executed. In step S1321, the image similarity of each concealed region between the image 1200 and the model intermediate output map 1250 is calculated. Here, the image similarity calculation unit 302 can calculate a plurality of similarities such as an edge similarity and a color similarity, for example. Any one of these pluralities may be used, or the result with the highest numerical value may be used as the image similarity. In this case, the similarity in terms of image color information between the image 1200 and the model intermediate output map 1250 is low, but the similarity in terms of image edge information is high, and the calculated similarity is 0.8.

In step S1322, an image conversion parameter corresponding to the similarity is obtained. Here, the image similarity (0.8) between the image 1200 and the model intermediate output map 1250 is equal to or greater than the threshold (0.5). Thus, it is determined to execute blanking out processing of the concealed region.

In step S1323, blanking out processing of the output map is executed. Here, the region where blanking out processing is executed is the region on the output map corresponding to the region where the concealed regions 1221 and 1222 of the personal information concealed image 1220 are applied. The subsequent processing is similar to that described relating to the eyes output map and thus will not be described. Here, it is assumed that a display image 1280 of FIG. 12 is generated. As can be seen from the display image 1280, the model intermediate output map 1250 is superimposed on the personal information concealed image 1220, and the concealed region is blanked out.

Thereafter, in step S1309, since the processing of all of the output maps has ended, the processing proceeds to step S1311. In step S1311, the model output map display unit 331 displays the generated display image to the user B.

As described above, in the present embodiment, personal information can be concealed even when confirming the training status of machine learning, and the user B who cannot know the original image can be visually supported.

Note that in the example according to the present embodiment described above, training tasks for the eyes and face are all tasks that can be displayed on the display screen. However, no such limitation is intended. For example, it may be determined whether or not to display the output map on the display screen depending on the label information applied to the image. For example, an output map may be displayed for an eye label and a face label, but an output map may not be displayed for a mouth label. Also, a displayable task may be set for each image.

### Modified Example

In the embodiments described above, person are used in the examples. However, a different category such as a dog or scenery may be used as the target. When the embodiments described above are applied to another category, training can be performed using the original image while concealing personal information.

Also, in the examples according to the embodiments described above, the information processing apparatus illustrated in FIG. 2 is a single apparatus. However, no such limitation is intended. For example, an operating terminal including the user interface unit 210 and the internal processing unit 220 may be possessed by both the user A and the user B, with each operating terminal being used in the operations. Also, the data management unit 230 may be a server apparatus or the like connected via a network, and the internal processing unit 220 may be a part of an information processing apparatus managed on a network.

According to the present invention, machine learning can be performed using original images while protecting personal information.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-048569, filed Mar. 25, 2024, which is hereby incorporated by reference herein in its entirety.

What is claimed is:

1. An information processing apparatus comprising:
a determining unit configured to determine a concealed region for concealing personal information in a first image;
a concealing unit configured to execute concealing processing on the first image on a basis of the concealed region;
an applying unit configured to apply label information to the concealed region;
a display unit configured to display the label information superimposed on a second image, which is a concealed image obtained by executing the concealing processing; and
a training unit configured to perform training using the first image.

2. The information processing apparatus according to claim 1, wherein the label information includes one region label of at least one of a face label, an eye label, and a mouth label of a human included in the first image.

3. The information processing apparatus according to claim 1, wherein the label information includes one classification label of at least one of a category label, a gender label, and an orientation label of a human included in the first image.

4. The information processing apparatus according to claim 1, further comprising:
a management unit configured to manage a plurality of images including the first image and a plurality of concealed images including the second image.

5. The information processing apparatus according to claim 4, further comprising:
an image similarity calculating unit configured to calculate an image similarity between the concealed region of the first image and a concealed region of other images managed by the management unit, wherein
the display unit obtains and displays an image with the image similarity of equal to or greater than a threshold from among the other images managed by the management unit.

6. The information processing apparatus according to claim 4, further comprising:
a label similarity calculating unit configured to calculate a label similarity between label information applied to the concealed region of the first image and label information applied to other images managed by the management unit, wherein
the display unit obtains and displays an image with the label similarity of equal to or greater than a threshold from among the other images managed by the management unit.

7. The information processing apparatus according to claim 1, further comprising:
a similar image generating unit configured to convert the concealed region into a similar image, wherein
the display unit displays the second image obtained by converting the concealed region into the similar image.

8. The information processing apparatus according to claim 7, further comprising:
a calculating unit configured to calculate an image similarity between the first image and the second image obtained by converting the concealed region into the similar image, wherein
in a case where the image similarity is equal to or greater than a first threshold and equal to or less than a second threshold greater than the first threshold, the display unit displays the second image obtained by converting the concealed region into the similar image.

9. The information processing apparatus according to claim 1, wherein the first image is associated with a training use information,
a score calculating unit configured to calculate a training use recommendation score on a basis of the training use information of the first image is provided, and
the display unit further displays the training use information and the training use recommendation score.

10. The information processing apparatus according to claim 9, wherein the training use information includes at least one of accuracy improvement rate when using the first image in training, the number of times the first image is used in training, and a number of high ratings for the first image.

11. The information processing apparatus according to claim 1, further comprising:
a map display unit configured to display a model output map obtained as a result of performing training with a model being input with the first image.

12. The information processing apparatus according to claim 11, further comprising
a converting unit configured to image-convert the model output map on a basis of the concealed region of the first image, wherein
the map display unit displays a model output map obtained by conversion via the converting unit.

13. The information processing apparatus according to claim 12, further comprising
a calculating unit configured to calculate a similarity between the first image and the model output map; and
a parameter determining unit configured to determine a conversion parameter to be used by the converting unit so that the similarity is made equal to or less than a threshold.

14. The information processing apparatus according to claim 13, wherein the map display unit determines whether or not to display the model output map depending on label information applied to the first image.

15. The information processing apparatus according to claim 1, wherein the display unit displays the second image to a user when the user performs training using the first image.

16. A method for controlling an information processing apparatus comprising:
determining a concealed region for concealing personal information in a first image;
executing concealing processing on the first image on a basis of the concealed region;
applying label information to the concealed region;
displaying the label information superimposed on a second image, which is a concealed image obtained by executing the concealing processing; and
performing training using the first image.

17. A non-transitory computer-readable storage medium storing a program for causing a computer to execute a method for controlling an information processing apparatus comprising:
determining a concealed region for concealing personal information in a first image;
executing concealing processing on the first image on a basis of the concealed region;
applying label information to the concealed region;
displaying the label information superimposed on a second image, which is a concealed image obtained by executing the concealing processing; and
performing training using the first image.
